(19) United States
(12) Patent Application Publication
(10) Pub. No.: US 2008/0069751 A1
(43) Pub. Date: Mar. 20, 2008

(54) Method of neutralizing acid exhaust gas

(76) Inventors: Lawrence Bernard Kool, Clifton Park, NY (US); Gabriel Ofori-Okai, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/523,982

(22) Filed: Sep. 20, 2006

(51) Int. Cl. B01D 53/40

(52) U.S. Cl. 423/228; 423/229

(57) ABSTRACT

A method of treating an acidic component in an exhaust gas includes contacting the exhaust gas with an aqueous solution including a water-soluble amine that produces a water-soluble salt when reacted with the acidic component of the exhaust gas.

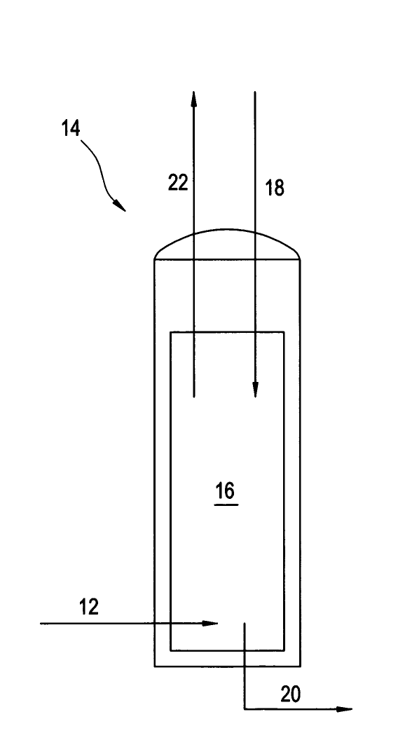

### BACKGROUND OF THE INVENTION

The present disclosure generally relates to the neutralization of acid exhaust gas in a scrubber.

A variety of coatings are used to provide oxidation resistance and thermal barrier properties to metal articles, such as turbine engine components. Coatings used for turbine engine components generally belong to one of two classes, that is, diffusion coatings or overlay coatings. Diffusion coatings are generally formed of aluminide-type alloys, such as nickel-aluminide, platinum-aluminide, or nickel-platinum-aluminide. Overlay coatings can have the composition MCrAl(X), where M is nickel (Ni), cobalt (Co), iron (Fe), or a combination of the foregoing, and X is yttrium (Y), tantalum (Ta), silicon (Si), hafnium (Hf), titanium (Ti), zirconium (Zr), boron (B), carbon (C) or a combination of the foregoing. Diffusion coatings are formed by depositing constituent components of the coating and reacting those components with elements from the underlying substrate. In contrast, overlay coatings are generally deposited intact, without reaction with the underlying substrate.

When articles such as gas turbines are serviced, the protective coatings are usually removed to permit inspection and possible repair of the underlying substrate. Removal of the coatings can be carried out by immersing the components in a stripping solution. A variety of stripping techniques can be employed for removing different types of coatings from metal substrates. One example of a particular treatment technique to remove metallic coatings and foreign matter is chemical etching. In such a process, the article is submerged in an aqueous chemical etchant. Foreign matter and the metallic coating on the article surface are then dissolved as a result of reaction with the etchant.

One such stripping process employs an aqueous composition comprising an acid having the formula HₓAF₆, or precursors to the acid. “A” is silicon (Si), germanium (Ge), titanium (Ti), zirconium (Zr), aluminum (Al), or gallium (Ga), and x is 1-6. Various coatings can be removed by this method, including diffusion coatings (e.g., aluminide-based) or overlay coatings of the MCrAl(X)-type. Precursors to the HₓAF₆ acid may also be used in the stripping process. Exemplary acids used in coatings removal processes include H₂SiF₆ and H₂ZrF₆.

Such stripping methods often emit acidic fumes. For example, one form of acid exhaust generated by the aforementioned coating removal process is fluosilicic acid, or H₂SiF₆ (g). These fumes are then scrubbed from ventilation exhaust systems. For example, one method of neutralizing fumes in a scrubber reaction involves the use of sodium hydroxide (NaOH) according to the following hydrolysis reaction:

6NaOH(aq)+H₂SiF₆(g)→6NaF+SiO₂+4H₂O

However, in a concurrent reaction, alkali metals such as sodium and potassium combine with fluosilicic acid to form insoluble sodium and potassium fluosilicates, such as insoluble sodium hexafluorosilicate, Na₂SiF₆, according to the following exemplary reaction:

2NaOH(aq)+H₂SiF₆(g)→Na₂SiF₆(s)+2H₂O

These salts precipitate as tenacious scales on process equipment such as scrubber packing, entrainment separators, pumps, and the like, causing operating delays for removal. More specifically, the process equipment is periodically shut down to clean out the sludge with an acid wash or mechanical removal.

Accordingly, a need exists for neutralizing acid exhaust gas that prevents and/or minimizes scrubber fouling and downtime.

### BRIEF DESCRIPTION OF THE INVENTION

Disclosed herein are methods of neutralizing acid exhaust gas.

In one embodiment, a method of treating an acidic component in an exhaust gas comprises contacting the exhaust gas with an aqueous solution comprising a water-soluble amine that produces a water-soluble salt when reacted with the acidic component of the exhaust gas.

The above described and other features are exemplified by the following FIGURE and detailed description.

### BRIEF DESCRIPTION OF THE DRAWING

The FIGURE is a schematic illustration of a method for removing acid components from an exhaust gas.

### DETAILED DESCRIPTION OF THE INVENTION

Disclosed herein is a method of treating exhaust gas comprising an acid having the formula HₓAF₆ or precursors to the acid, wherein “A” is silicon (Si), germanium (Ge), titanium (Ti), zirconium (Zr), aluminum (Al) or gallium (Ga), and x is 1-6. The acid is treated with a water-soluble amine to produce a water-soluble salt. As will be discussed in greater detail, use of a water-soluble amine (e.g., triethanol amine) prevents and/or minimizes the formation of insoluble solids and thereby eliminates or mitigates scrubber fouling problems.

As used herein, the term “soluble” refers to a compound that is highly soluble in water under atmospheric pressure at room temperature (about 21 degrees Celsius to about 23 degrees Celsius).

Referring to the FIGURE, an embodiment of a method of treating an acidic exhaust gas is schematically illustrated. An exhaust gas feedstream 12 is introduced into a scrubber 14. The feedstream 12 comprises an acid having the formula HₓAF₆, or precursors to the acid, where “A” is Si, Ge, Ti, Zr, Al, or Ga, and x is 1-6. For example, the feedstream 12 can comprise an acid gas released during a coating removal process. In one embodiment, the exhaust gas comprises at least fluosilicic acid, H₂SiF₆ (g).

The scrubber 14 can include any scrubber wherein it is achievable to contact an acidic exhaust gas with an aqueous solution for the purpose of neutralizing the exhaust gas. Suitable scrubbers include, but are not limited to, venturi scrubbers, jet venturi scrubbers, orifice scrubbers, fiber-bed scrubbers, mechanical scrubbers, impingement plate scrubbers, spray scrubbers, condensation scrubbers, cyclone spray chamber scrubbers, tray or sieve type scrubbers, packed scrubbers, spray towers, and the like.

Further, it is to be understood that the scrubber 14 may be employed alone or may be employed in series or parallel with one or more additional optional scrubbers. Design and operating parameters such as scrubber geometrical shape, liquid spray or injection locations, gas residence time, gas velocities, gas and liquid temperatures, gas and liquid pressure drop, and liquid/gas flow rate ratio will depend on what is suitable for the application.

In operation, the feedstream 12 is introduced into an absorption zone 16 of the scrubber 14, wherein it contacts an aqueous scrubber solution 18. The scrubber solution 18 neutralizes the acid within the feedstream 12 to produce a spent scrubber solution 20 and a clean gas stream 22 that comprises an acid volume within a threshold limit value (TLV) or personal exposure limit (PEL), which is set, for example, in the United States by the Occupational Safety and Health Administration (OSHA) and the National Institute for Occupational Safety and Health (NIOSH). These values and limits can vary depending on the regulations of different countries. For fluosilicic acid, the OSHA and NIOSH PEL are currently 2.5 milligrams (mg) per cubic meter. The scrubber solution 18 can be periodically replaced to refresh the neutralizing capabilities. In one embodiment, the spent scrubber solution 20 can be further processed to remove the acid such that it may be recycled back to the scrubber 14. The clean gas stream 22 is discharged either to the atmosphere or recycled for use in other processes.

The absorption zone 16 can include liquid sheets, wetted walls, bubbles and/or droplets, for example. The geometric designs and method for gas-liquid contact in the absorption zone 16 can occur by such designs as packed-bed, counter-flow, cross-flow, bubble-plate, open spray tower, dual-flow tray, cyclonic, and venturi designs. The particular design used for the absorption zone 16 will depend on the particular application. In one embodiment, the absorption zone 16 is a packed-bed design.

The scrubber solution 18 comprises a water-soluble amine capable of producing a water-soluble salt when reacted with the acid of the feedstream 12. Suitable water-soluble amines include, but are not limited to, ethanol amines such as monoethanol, diethanol amine and triethanol amine. Other water-soluble amines include, but are not limited to, propanol amines (e.g., monopropanol amine, dipropanol amine, and tripropanol amine) or methanol amines (e.g., monomethanol amine, dimethanol amine, and trimethanol amine). In another embodiment, the water-soluble amine comprises ammonia. In one embodiment, the acid of the feedstream 12 reacts with the aqueous triethanol amine solution to form a bi-acid and acid salt. In an exemplary embodiment, the acidic comprises H₂SiF₆ gas and the neutralization occurs according to the following reactions:

N(CH₂CH₂OH)₃(aq)+H₂SiF₆(aq)→[N(CH₂CH₂OH)₃]H₂SiF₆(aq)

[N(CH₂CH₂OH)₃]H₂SiF₆(aq)+N(CH₂CH₂OH)₃(aq)→[N(CH₂CH₂OH)₃]₂H₂SiF₆

The concentration of the water-soluble amine to be used in scrubber solution 18 is not specified as long as it is sufficiently high to neutralize the acidic components in the exhaust gas feedstream 12 during contacting of the gas with the scrubber solution 18. From the viewpoint of ease of handling, the concentration can be about 0.01% to about 30% by weight, specifically about 10% to about 25% by weight, wherein weight percents are based on a total weight of the scrubber solution.

The temperature of the aqueous scrubber solution 18 is not specified as long as it is sufficiently high to neutralize the acid in the exhaust gas feedstream 12 during contacting of the gas with the scrubber solution 18. In one embodiment, the temperature of the aqueous scrubber solution 18 is typically below ambient temperature as a result of evaporative cooling. In another embodiment, such as in cooler climates, the scrubber solution may be heated to increase solubility of the amine salt of, for example, fluorosilicic acid. The pressure of the exhaust gas feedstream 12 may be atmospheric. In specific embodiments, atmospheric pressure of the exhaust gas feedstream 12 may be greater than atmospheric. Advantageously, operation at a pressure greater than atmospheric may enable the size of the scrubber equipment employed to be reduced, which may be sufficient to reduce equipment costs and/or reduce operating costs.

The extent of absorption of acidic components of the exhaust gas feedstream 12 in the scrubber solution 18 varies with the volume of scrubber solution 18 in use, the concentration of the water-soluble amine in the scrubber solution 18, the method of contact, and the like. In one embodiment, the scrubber solution 18 can be withdrawn as spent scrubber solution 20 when its pH reaches near the neutral value. In an exemplary embodiment, scrubber solution 18 can be withdrawn as spent scrubber solution 20 when its pH value is about 7.1 to about 8.

The spent scrubber solution 20 can be disposed of by such means as incineration or, if necessary, contacted with calcium carbonate or the like to precipitate the acidic components in the spent scrubber solution 20 as a salt. In the cases where the spent scrubber solution 20 is contacted with calcium carbonate to precipitate the acidic components in the spent solution as calcium salts, agitation of the spent solution and calcium carbonate is effected by a stirrer or by a static mixer on a batchwise or continuous basis.

Advantageously, the aqueous solution of the water-soluble amine, such as triethanol amine, used as a scrubber solution according to the present disclosure yields highly soluble products. The formation of soluble products possesses an excellent advantage over methods for hydrolysis of fluosilicic acid because the neutralization reactions form soluble acid salts rather than the insoluble fluosilicates formed in hydrolysis reactions. Therefore, scrubber fouling can be prevented and/or minimized, which in turn minimizes scrubber downtime. Additionally, it is possible to operate the method for treating the acidic exhaust gas in a complete solution system with extreme ease of maintenance. Furthermore, triethanol amine is inexpensive, environmentally friendly and non-polluting. It causes no harm to acid neutralization processes used in waste treatment systems.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method of treating an acidic component in an exhaust gas, the method comprising:
contacting the exhaust gas with an aqueous solution comprising a water-soluble amine that produces a water-soluble salt when reacted with the acidic component of the exhaust gas.

2. The method of claim 1, wherein the acid component comprises an acid having a formula HₓAF₆, wherein A is silicon, germanium, titanium, zirconium, aluminum, or gallium, and x is 1-6.

3. The method of claim 1, wherein the acid component comprises fluosilicic acid.

4. The method of claim 1, wherein the water-soluble amine comprises diethanol amine and triethanol amine.

5. The method of claim 1, wherein the water-soluble amine comprises a propanol amines or a methanol amine.

6. The method of claim 1, wherein the water-soluble amine comprises ammonia.

7. The method of claim 1, wherein the exhaust gas is contacted with the aqueous solution within a scrubber device.

8. The method of claim 1, wherein the water-soluble amine is present in the aqueous solution in an amount of about 0.01% to about 30% by weight.

9. The method of claim 8, wherein the water-soluble amine is present in an amount of about 10% to about 25% by weight.

10. A method of treating an acidic component in an exhaust gas, the method comprising:
contacting the exhaust gas with an aqueous solution, wherein the acidic component comprises an acid having a formula HₓAF₆, wherein A is silicon, germanium, titanium, zirconium, aluminum, or gallium, and x is 1-6, and wherein the aqueous solution comprises a water-soluble amine selected from the group consisting of an ethanol amine, a propanol amine, a methanol amine, or a combination comprising at least one of the foregoing.

11. The method of claim 10, wherein the acid component comprises fluosilicic acid.

12. The method of claim 10, wherein the water-soluble amine is present in the aqueous solution in an amount of about 0.01% to about 30% by weight.

13. The method of claim 12, where the water-soluble amine is present in an amount of about 10% to about 25% by weight.

14. A method of treating an acidic component in an exhaust gas, the method comprising:
contacting the exhaust gas with an aqueous solution within a scrubber device, wherein the acidic component comprises fluosilicic acid and wherein the aqueous solution comprises a water-soluble amine selected from the group consisting of an ethanol amine, a propanol amine, a methanol amine, or a combination comprising at least one of the foregoing.

15. The method of claim 14, wherein the water-soluble amine is present in the aqueous solution in an amount of about 0.01% to about 30% by weight.

16. The method of claim 15, wherein the water-soluble amine is present in an amount of about 10% to about 25% by weight.
